(19) United States
(12) Patent Application Publication
(10) Pub. No.: US 2024/0013279 A1
(43) Pub. Date: Jan. 11, 2024

(54) INFORMATION PROCESSING DEVICE

(71) Applicant: PIGNUS INC., Minato-ku, Tokyo (JP)

(72) Inventors: Shohei MITO, Tokyo (JP); Kaoru OKAMOTO, Tokyo (JP)

(21) Appl. No.: 18/253,107

(22) PCT Filed: Aug. 20, 2021
(86) PCT No.: PCT/JP2021/030574

§ 371 Date: May 16, 2023

(30) Foreign Application Priority Data
Nov. 16, 2020 (JP) 2020-190071

(51) Int. Cl. G06Q 30/0601

(52) U.S. Cl. CPC G06Q 30/0631; G06Q 30/0625

(57) ABSTRACT

The present invention enables easy finding of software that includes a functionality required by a user. A server 1 in an information processing system is provided with a reception unit 112, an expression form conversion unit 113, a selection condition setting unit 114, and a presentation unit 115. The reception unit 112 receives, in a form that includes a universal first expression form, a user request for software. The expression form conversion unit 113 converts the request received in the first expression form to a specialized second expression form. The selection condition setting unit 114 sets one or more selection conditions for selecting software on the basis of the request, which has been converted to the second expression form. The presentation unit 115 presents one or more pieces of software to a user on the basis of the one or more selection conditions.

### RELATED APPLICATION INFORMATION

This patent claims priority from International PCT Patent Application No. PCT/JP2021/030574, filed Aug. 20, 2021 entitled, “INFORMATION PROCESSING DEVICE”, which claims priority to Japanese Patent Application No. 2020-190071, filed Nov. 16, 2020, all of which are incorporated herein by reference in their entirety.

A portion of the disclosure of this patent document contains material which is subject to copyright protection. This patent document may show and/or describe matter which is or may become trade dress of the owner. The copyright and trade dress owner has no objection to the facsimile reproduction by anyone of the patent disclosure as it appears in the Patent and Trademark Office patent files or records, but otherwise reserves all copyright and trade dress rights whatsoever.

### TECHNICAL FIELD

The present invention relates to an information processing apparatus.

### BACKGROUND ART

Recently, there have been many mail order sites where a comparison table of commodities selected as comparison targets by a user is displayed so that a commodity selected from the comparison table is set as a purchase candidate. Conventionally, there has been proposed a software sale system making it possible for a user to select and purchase software that includes functions the user requires, via the Internet (see, for example Patent Document 1).
Patent Document 1: Japanese Unexamined Patent Application, Publication No. 2001-344034

### SUMMARY OF THE INVENTION

### Problems to be Solved by the Invention

In prior-art techniques including the technique of Patent Document 1 described above, however, a user has to find software among pieces of software categorized by the sale site side in advance, and software that includes functions the user really needs is not necessarily found.

The present invention has been made in view of such a situation, and an object is to make it possible for a user to easily find software that includes functions the user requires.

### Means for Solving the Problems

In order to achieve the above object, an information processing apparatus of one aspect of the present invention includes:
an acceptance unit accepting a request of a user for software in a form including a general first expression form;
a conversion unit converting the request accepted in the first expression form into a technical second expression form;
a setting unit setting one or more selection conditions for selecting software based on the request converted in the second expression form; and
a presentation unit presenting one or more pieces of software to the user based on the one or more selection conditions.

### Effects of the Invention

According to the present invention, it is possible for a user to easily find software that includes functions the user requires.

### DESCRIPTION OF THE DRAWINGS

FIG. 1 is a diagram showing a site map of a software comparison site;

FIG. 2 is a diagram showing a configuration example of an information processing system utilizing the software comparison site of FIG. 1, that is, an information processing system including a server that is one embodiment of an information processing apparatus of the present invention;

FIG. 3 is a block diagram showing a hardware configuration of the server in the information processing system of FIG. 2;

FIG. 4 is a functional block diagram showing an example of a functional configuration of the server of FIG. 3;

FIG. 5 is a diagram showing a software diagnosis page linked to a page of “Electronic Contract Services” from a page of “Select Software” on the site map shown in FIG. 1;

FIG. 6 is a diagram showing a page continued from the page of FIG. 5;

FIG. 7 is a diagram showing a question/answer page displayed by clicking a “Start diagnosis” button on the page of FIG. 5;

FIG. 8 is a diagram showing a page for confirming selection conditions as a result of questioning and answering;

FIG. 9 is a diagram showing a page continued from the page of FIG. 8;

FIG. 10 is a diagram showing a list of electronic contract services searched based on the selection conditions;

FIG. 11 is a diagram showing a page continued from the page of FIG. 10;

FIG. 12 is a diagram showing a page on which content of one service selected from the list of electronic contract services is written;

FIG. 13 is a diagram showing a page continued from the page of FIG. 12;

FIG. 14 is a diagram showing a page continued from the page of FIG. 13;

FIG. 15 is a diagram showing a page on which content of a plan of the electronic contract service of FIG. 12 is written; and

FIG. 16 is a diagram showing a page continued from the page of FIG. 15.

### DISCLOSURE OF THE INVENTION—PREFERRED MODE FOR CARRYING OUT THE INVENTION

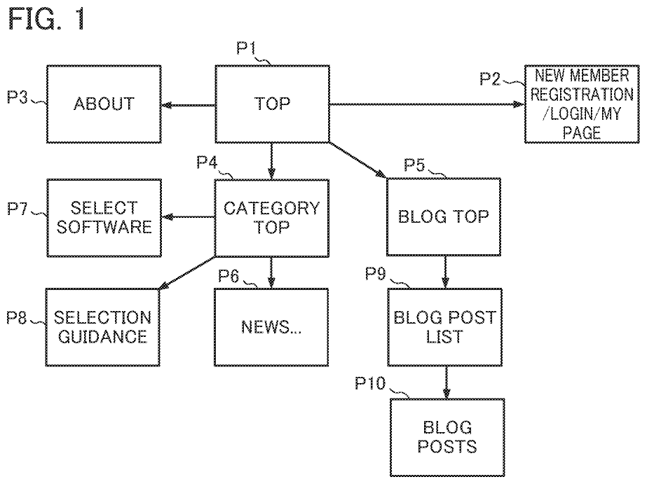

An embodiment of the present invention is described below using drawings. Description is made on a site map of a software comparison site to which an information processing apparatus according to the embodiment of the present invention is applied with reference to FIG. 1. FIG. 1 is a diagram showing the site map of the software comparison site.

The software comparison site is provided with a Top page P1. To the Top page P1, a Member page P2, an About page P3, and pages of Category Top P4, Blog Top P5, and the like are linked. To the page of Category Top P4, pages of News P6, Select Software P7, Guide for Selection P8, and the like are linked. To the page of Blog Top P5, Blog Post List P9, and Blog Posts P10 are linked.

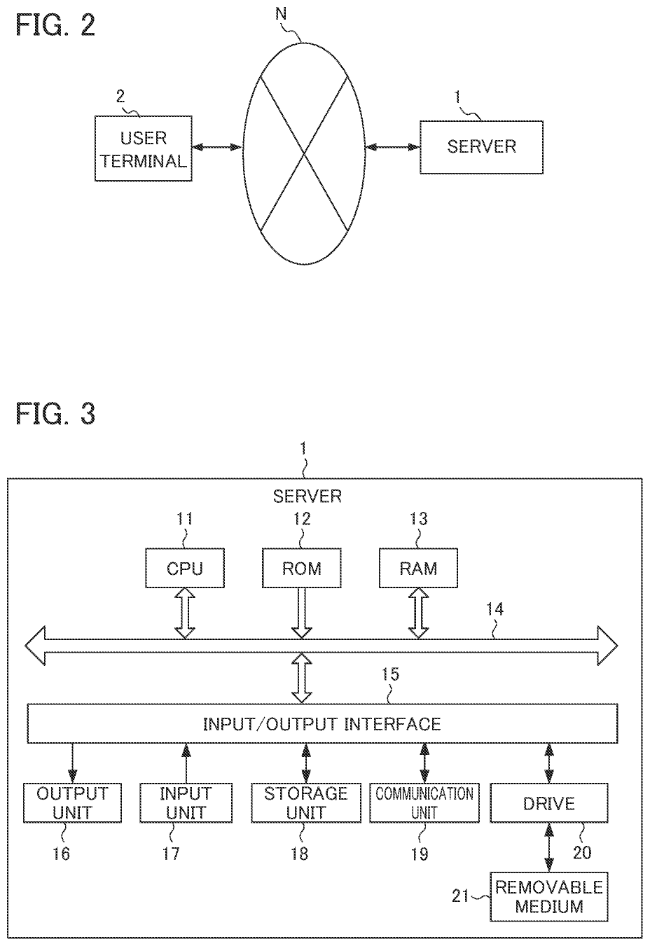

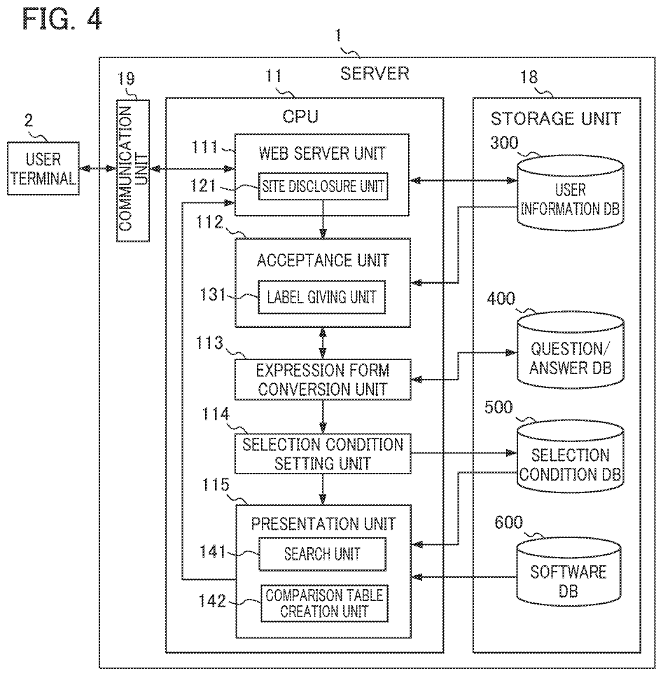

On the software comparison site of the site map shown in FIG. 1, a user can select software on the page of Select Software P7. The information processing apparatus according to the embodiment of the present invention (a web server unit 111 of a server 1 of FIG. 4 described later) discloses the software comparison site (website) of the site map shown in FIG. 1 on the Internet or the like (for example, a network N in FIG. 2 described later).

Next, description is made on an information processing system utilizing the software comparison site shown in FIG. 1 with reference to FIGS. 2 to 4. FIG. 2 is a diagram showing a configuration example of the information processing system utilizing the software comparison site shown in FIG. 1, that is, an information processing system including a server that is one embodiment of the information processing apparatus of the present invention.

The information processing system shown in FIG. 2 is configured so that the server 1 and a user terminal 2 are connected to perform communication via the network N such as the Internet. The server 1 is managed by an operator of the software comparison site. The user terminal 2 is operated by a user who uses the software comparison site.

FIG. 3 is a block diagram showing a hardware configuration of the server in the information processing system of FIG. 2.

The server 1 includes a CPU (central processing unit) 11, a ROM (read-only memory) 12, a RAM (random access memory) 13, a bus 14, an input/output interface 15, an output unit 16, an input unit 17, a storage unit 18, a communication unit 19, and a drive 20.

The CPU 11 executes various kinds of processes according to a program recorded on the ROM 12 or a program loaded from the storage unit 18 to the RAM 13. In the RAM 13, data and the like required for the CPU 11 to execute the various kinds of processes are appropriately stored.

The CPU 11, the ROM 12, and the RAM 13 are mutually connected via the bus 14. To the bus 14, the input/output interface 15 is also connected. To the input/output interface 15, the output unit 16, the input unit 17, the storage unit 18, the communication unit 19, and the drive 20 are connected.

The output unit 16 is configured with a display, a speaker, and the like and outputs various kinds of information as images and voice. The input unit 17 is configured with a keyboard, a mouse, and the like and inputs various kinds of information.

The storage unit 18 is configured with a hard disk, a DRAM (dynamic random access memory), or the like and stores various kinds of data. The communication unit 19 performs communication with other apparatuses (in the example of FIG. 2, the user terminal 2) via the network N including the Internet.

In the drive 20, a removable medium 21 configured with a magnetic disk, an optical disc, a magneto-optical disk, a semiconductor memory, or the like is appropriately fitted. A program read from the removable medium 21 by the drive 20 is installed into the storage unit 18 as necessary. The removable medium 21 can also store the various kinds of data stored in the storage unit 18 similarly to the storage unit 18. Although not shown in Figure, the user terminal 2 of the information processing system of FIG. 2 has a configuration that is basically similar to the hardware configuration shown in FIG. 3.

An example of a functional configuration of the server of FIG. 3 is described below with reference to FIG. 4. FIG. 4 is a functional block diagram showing the example of the functional configuration of the server of FIG. 3.

In an area of the storage unit 18 of the server 1 shown in FIG. 3, a user information DB 300, a question/answer DB 400, a selection condition DB 500, and a software DB 600 are provided as shown in FIG. 4. In the user information DB 300, information inputted when each user using the software comparison site made a membership registration is stored. Information stored in the user information DB 300 includes, for example, a member ID as a member of the software comparison site, name, gender, address, contact information (telephone number, e-mail address, and the like), software diagnosis history, method of payment at the time of purchasing software and the like.

In the question/answer DB 400, in order to show one or more pieces of software for comparison, which are appropriate for a request of each member (user), information about questioning and answering for acquiring the request of the member (hereinafter referred to as “question/answer information”) is stored. Specifically, for example, a plurality of sets of a question to each user and answer choices for the user to the question (question/answer sets) are registered with the question/answer DB 400. Moreover, the plurality of question/answer sets are not simply stored in the question/answer DB 400 but are stored in the question/answer DB 400 as a question/answer logic in which the question/answer sets branch in a tree structure so that, according to how the user selects an answer choice, the next question changes.

For example, if there are a first question/answer set in which answers A and B are prepared as answer choices, a second set including a question “a” and a third set including a question “b”, and it is desired to extract the question “a” as the next question in the case of the user selecting the answer A and extract the question “b” as the next question in the case of the user selecting the answer B in the first set, then the second and third sets are stored in the question/answer DB 400 being associated with the answers A and B of the first set, respectively.

In the selection condition DB 500, a plurality of conditions for selecting one or more pieces of software suitable for a request of the user (hereinafter referred to as “selection conditions”) are stored. By questioning to and answering from the user (presentation of the question/answer sets described above to the user) being repeated, selection conditions suitable for the request of the user are extracted from the selection condition DB 500 as a result of the repeated questioning and answering, the details of which are described later.

Though software presented to the user as such that is suitable for the request of the user may be any software, it is assumed here that information is stored in the software DB 600 for convenience of description. In the software DB 600, information about software for sale is stored. Specifically, for each of the one or more pieces of software for sale, for example, a name, a product number, a selling price, functions and specifications of the software, hardware application conditions, and the like are stored in the software DB 600, as the information about software.

Here, when a software selection process is executed on the software comparison site having the site map of FIG. 1, the web server unit 111, an acceptance unit 112, an expression form conversion unit 113, a selection condition setting unit 114, and a presentation unit 115 function in the CPU 11 of the server 1. The software selection process refers to a series of processes of repeating questioning to and answering from the user, setting one or more selection conditions suitable for the request of the user as a result of the repeated questioning and answering, and selecting one or more pieces of software suitable for the request of the user based on the one or more selection conditions.

The web server unit 111 has a site disclosure unit 121. The site disclosure unit 121 discloses the software comparison site on the network N such as the Internet. In this example, the software comparison site is configured based on the site map shown in FIG. 1. Though it is included within the scope of the disclosure to enable the website to be disclosed only to members, it is assumed in this example that those who are not members can view the software comparison site. If a user terminal 2 of a user who is not a member accesses the software comparison site, the web server unit 111 prompts the user who has accessed the software comparison site to make a member registration. When the user makes a member registration on the Member page P2 (see FIG. 1) of the software comparison site, the web server unit 111 causes information about the user to be stored into the usage information DB 300 to manage the information.

The acceptance unit 112 accepts the request of the user for software in a form including a general first expression form. Here, the general first expression form is paired with a technical second expression form described later and refers to a form in which terms and expressions that are understandable to those who do not belong to the field of software (in this example, the user) are used.

For example, a form in which the user specifically describes usefulness for himself in using software for work and the like is an example of the general first expression form. Specifically, for example, a form of expression indicating the request of the user based on the user himself, such as desiring to digitize one-hundred-people-scale contract work using registered seals without printing, is an example of the general first expression form. In addition, the first expression form may be, for example, an expression form in which it is described that a sole proprietor who runs a restaurant business is going to construct a website for advertising his restaurant but does not require blog and mail-order functions for the website. An expression form is also possible in which it is described that, in a company preparing for being listed on the stock exchange, an employee who is inexperienced in accounting work is going to perform accounting work.

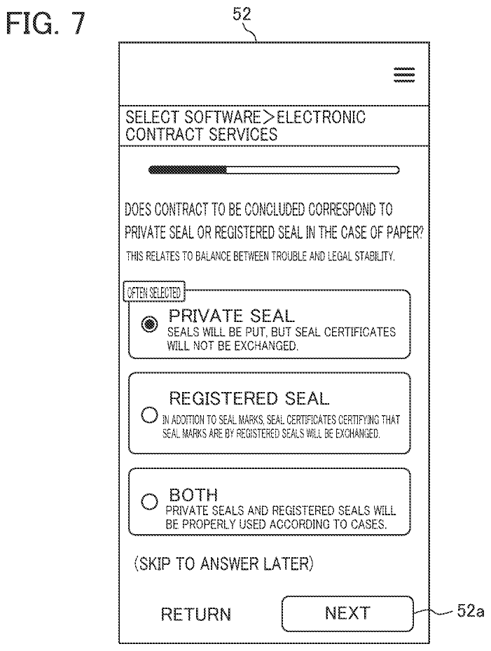

For example, in this example, the acceptance unit 112 subdivides the request in the general first expression form and accepts each of the subdivided requests one by one in a question/answer form (see FIGS. 7 to 9). That is, the acceptance unit 112 accepts the request of the user in a form including the first expression form by repeating questioning to and answering from the user (the user terminal 2). Each question in the questioning and answering is given with one or more choices.

Specifically, for example, the acceptance unit 112 refers to the question/answer DB 400 and presents a predetermined question/answer set, that is, a question (Q) for the user and choices (a plurality of selectable answers (A)) to the question (Q) on the user terminal 2, as shown in FIGS. 7 to 9. Then, the acceptance unit 112 accepts an answer (A) selected by an operation of the user terminal 2 by the user. Such a series of processes is executed for each of the plurality of question/answer sets. At this time, as described above, a question/answer set presented to the user next changes according to which of the plurality of answers (A) constituting the choice has been selected by the user.

The acceptance unit 112 includes a label applying unit 131. The label applying unit 131 applies a label to at least one of the plurality of answers (A) constituting the choices presented to the user. Specifically, for example, the label applying unit 131 makes a history of statistics of answers (A) selected for the question (Q) given to many users in the past, and applies a label of, for example, “Often selected”, “Recommended”, or “Non-recommended” to a predetermined answer (A) based on the history of statistics. The applied label is presented at a position near a corresponding answer (A) among the plurality of answers (A) of the choices of the question/answer set.

The expression form conversion unit 113 converts the request of the user in the general first expression form accepted by the acceptance unit 112 to the technical second expression form. Here, the technical second expression form is paired with the general first expression form described above and refers to a form in which technical terms and technical expressions that are understandable to those who belong to the field of software (in this example, a vendor or a supplier) are used. For example, an expression form in which a use environment and specification conditions of software, corresponding work, and the like are described based on the way of thinking of a vendor or a supplier is an example of the technical second expression form.

Specifically, for example, it is assumed that the user makes a request to “digitize one-hundred-people-scale contract work using registered seals without printing” in the first expression form. In this case, the expression form conversion unit 113 converts, for example, “contract work” to a technical term of “contract conclusion”, “registered seals” and “digitize” to a technical term of “electronic signature”, “without printing” to a technical term of “electronic file storage”, and “one-hundred-people-scale” to a technical term of “with one hundred or more users” or the like.

In addition, the technical second expression form includes a design thought and specifications. The design thought is also referred to as a concept, an idea, or the like. The design thought is a core part in which the characteristics of software are abstracted. The specifications are obtained by embodying the design thought. As MA (marketing automation) tools, for example, “Pardot”, “Salesforce Marketing Cloud” exist. Both are MA tools of Salesforce Company. “Pardot” is for increasing B-to-B face-to-face business negotiations, and “Salesforce Marketing Cloud” is for deepening communication with a client for commodities which are inexpensive and for which an examination process is short, such as articles for daily use.

For the technical second expression form, a suitable type of users, balance between high functionality and simplicity, a use fee, and the like are considered. The suitable type of users includes the industrial field to which the user belongs, the number of employees, the number of users, existence/nonexistence of a full time person in charge of IT, and the like. For the balance between high functionality and simplicity, the two are in a trade-off relationship. For example, while “Salesforce Sales Cloud” is highly functional and complicated, “Zoho CRM” is, on the contrary, lowly functional and simple, though both are SFA (Sales Force Automation). The use fee is set not for each piece of software but set for each plan of a subordinate concept. An appropriate plan is applied according to selection conditions, and an approximate fee is calculated. A method for such conversion is not especially limited. For example, in addition to a method using a term conversion dictionary or the like, a method using AI (a machine learning model or the like) may be adopted in which, when a request of the user in the general first expression form is inputted, the request in the technical second expression form is outputted.

The selection condition setting unit 114 sets one or more selection conditions for selecting software based on the request of the user converted into the technical second expression form and stores the one or more selection conditions into the selection condition DB 500. Specifically, for example, the selection condition setting unit 114 sets various kinds of technical terms constituting the technical second expression form as keywords, for example sets contract conclusion, electronic signature, electronic file storage, one hundred or more users, and the like as keywords, sets each of the keywords as each of the selection conditions and stores the selection conditions into the selection condition DB 500. The selection conditions are not necessarily required to be keywords or the like, but sentences, images, and the like are also possible. For example, it is also possible to adopt the request of the user itself expressed in the technical second expression form as a selection condition.

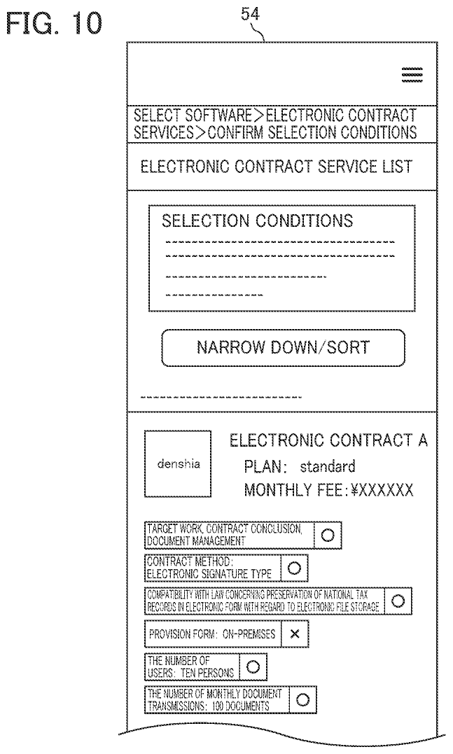

The presentation unit 115 presents one or more pieces of software to the user based on the one or more selection conditions set by the selection condition setting unit 114. Specifically, for example, the presentation unit 115 searches the software DB 600 based on the one or more selection conditions read from the selection condition DB 500, and presents a list of one or more pieces of software information obtained as a search result to the user by causing the list to be displayed on the user terminal 2 as an Electronic Contract Services List screen 54 (see FIG. 10).

By configuring the server 1 of the information processing system as above, the expression form conversion unit 113 converts the request of the user in the general first expression form to the request in the technical second expression form on the software comparison site. The selection condition setting unit 114 sets one or more selection conditions based on the technical second expression form. The presentation unit 115 searches for one or more pieces of software in the software DB 600 based on the one or more selection conditions and presents the pieces of software to the user. Thereby, the user can easily find software that includes functions the user needs only by answering questions in his own sense (in the general first expression that is understandable to himself), in other words, without using the technical second expression form. In addition, since a relation between the first expression form and the second expression form is known prior to evaluation of software, it is possible to know selection conditions required at the time of the user finding software from the user's point of view. Usually, since software makers transmit information from their own positions, it is difficult to compare their pieces of software on the same basis. In this information processing system, however, it is possible to view evaluations of pieces of software side by side. That is, the software comparison site published (disclosed) by the server 1 of this information processing system can provide side-by-side evaluations on an important issue.

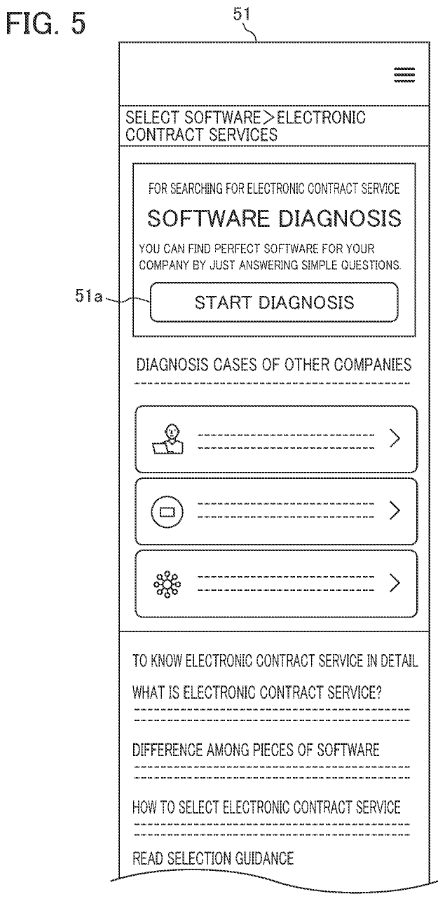

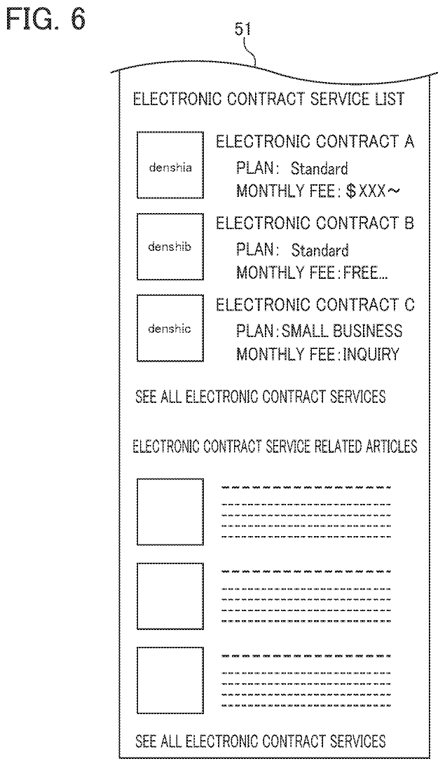

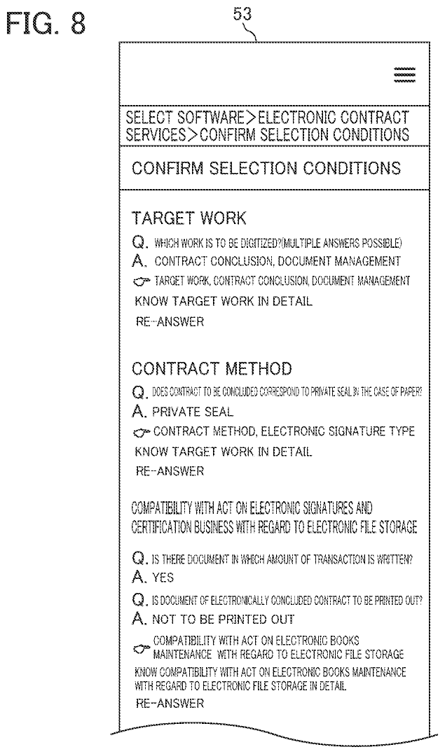

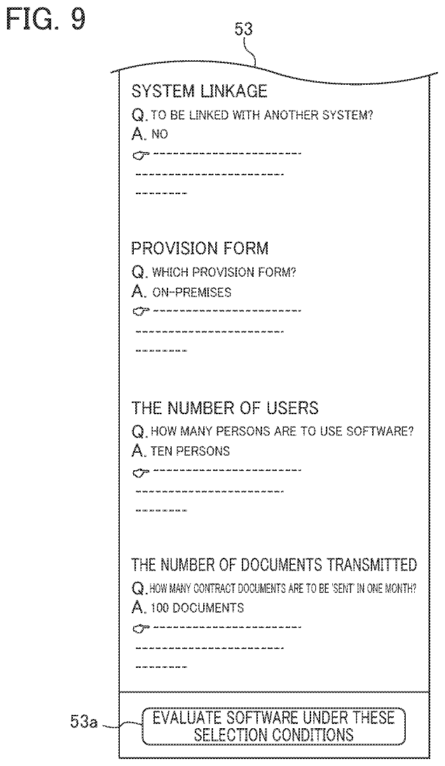

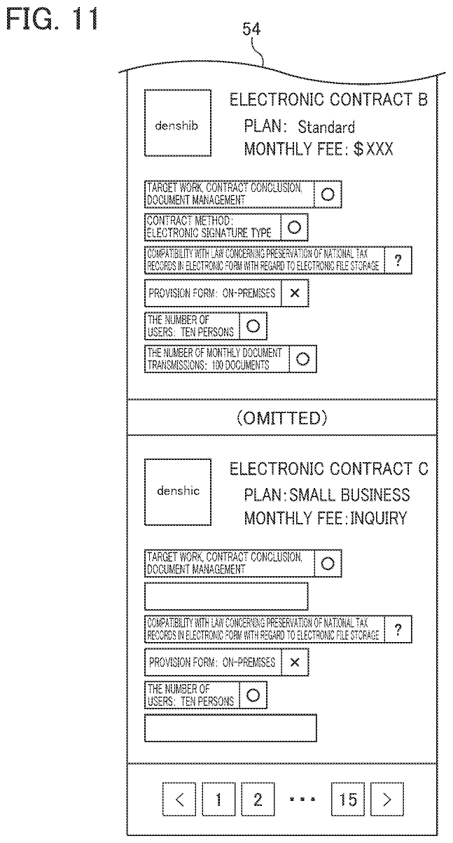

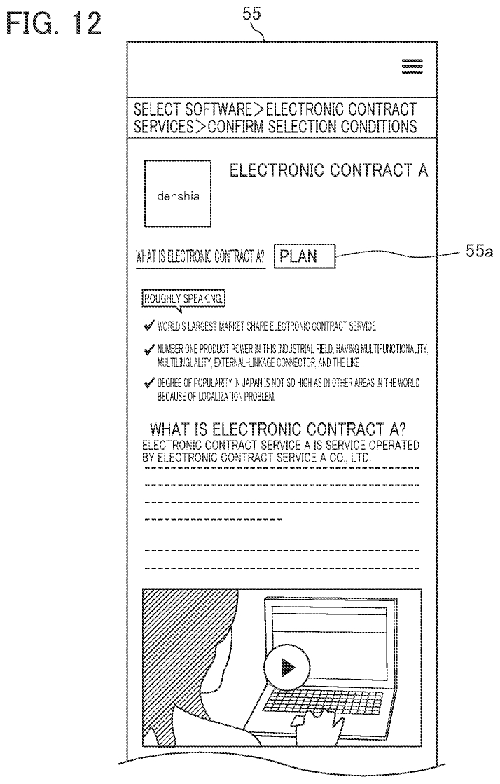

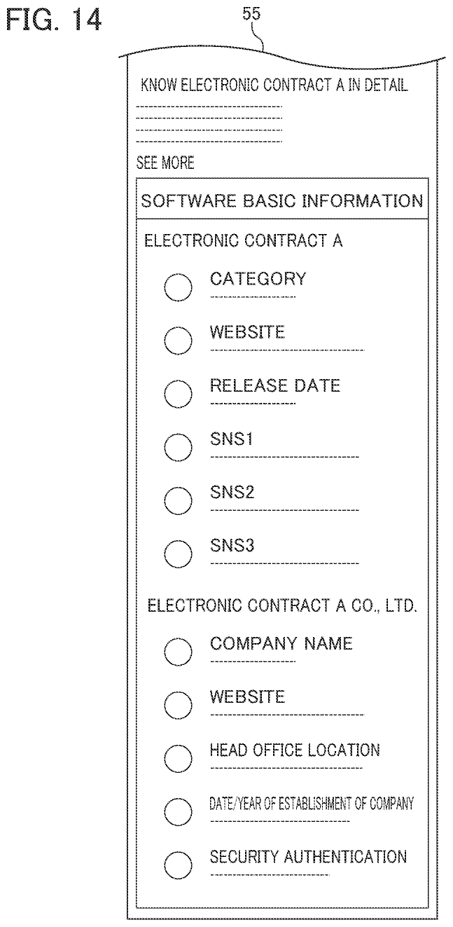

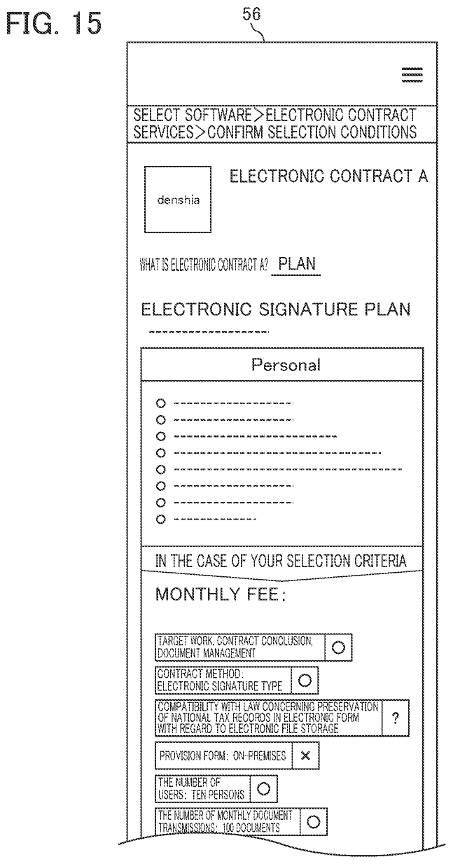

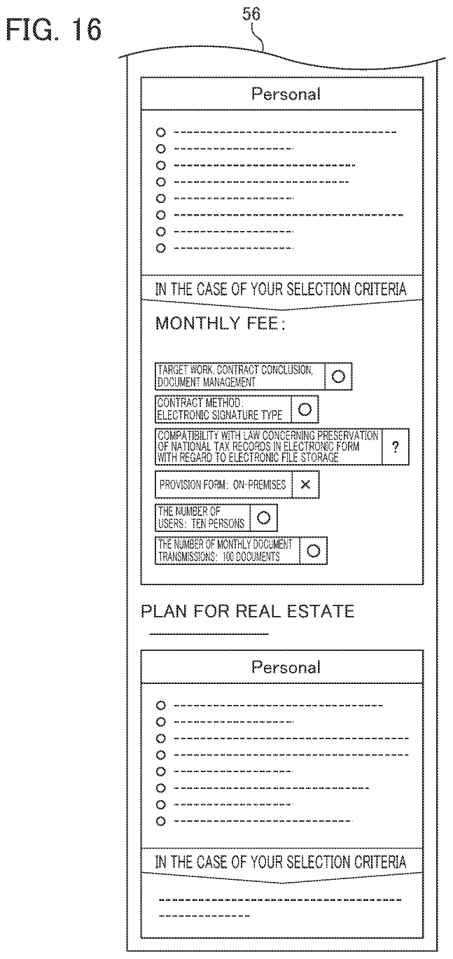

Next, operation of the server 1 described above is described with reference to FIGS. 5 and 16. FIG. 5 is a diagram showing a software diagnosis page linked to a page of “Electronic Contract Services” from a page of “Select Software” on the site map shown in FIG. 1. FIG. 6 is a diagram showing a page continued from the page of FIG. 5. FIG. 7 is a diagram showing a question/answer page displayed by clicking a “Start diagnosis” button on the page of FIG. 5. FIGS. 8 and 9 are diagrams showing a page for confirming selection conditions as a result of questioning and answering. FIGS. 10 and 11 are diagrams showing a list of electronic contract services searched based on the selection conditions. FIGS. 12 and 14 are diagrams showing a page on which content of one service selected from the list of electronic contract services is written. FIGS. 15 and 16 are diagrams showing a page on which content of a plan of the electronic contract service of FIG. 12 is written.

The user performs the following operations using the user terminal 2. Hereinafter, the user terminal 2 will not be mentioned. When the user performs a click operation on Select Software P7 on the site map of FIG. 1, and further performs a click operation on “Electronic Contract Services” from a displayed menu, a software diagnosis page 51 shown in FIGS. 5 and 6 is displayed by the site disclosure unit 121 of the web server unit 111.

On the software diagnosis page 51, in addition to a “Start diagnosis” button 51a, content is written under items of “Diagnosis Cases of Other Companies”, “To Know Electronic Contract in Detail”, “List of Main Electronic Contract Services”, and “Articles Related to Electronic Contract Services”, and the like.

Here, when the user performs a click operation on the “Start diagnosis” button 51a on the software diagnosis page 51, a question/answer page (not shown) is displayed by the acceptance unit 112. On various kinds of question/answer pages exemplified below, question/answer sets described in forms including the general first expression form are displayed. That is, for example, a question (Q) of “Which work is desired to be digitized? (multiple answers possible)” is displayed on the question/answer page, and, for example, two answers of “Often selected”/“Contract conclusion” and “Often selected”/“Document management” are displayed as answer choices for the user. The answers (A) constituting the choices are “Contract conclusion” and “Document management”, and “Often selected” before each of the answers (A) is a label applied to each of the answers (A). For “Contract conclusion”, as an explanation, a description that a contract is concluded not with “paper and a seal” but on the Internet, or the like is given. For “Document management”, as an explanation, a description that a contract document is electronically managed, or the like is given.

If, for example, “Contract conclusion” is selected by the user, and a click operation is performed on a “Next” button, on the question/answer page described above, then the next question/answer page 52 (see FIG. 7) is displayed. On the question/answer page 52, for example, a question (Q) such as “Does the contract to be concluded correspond to private seal or registered seal in the case of paper?” is displayed, and, for example, answers (A) of “Private seal”, “Registered seal”, and “Both” are displayed as answer choices for the user. At a position near “Private seal”, the characters (the label) of “Often selected” are displayed. The choices can be skipped to make an answer later.

If, for example, the answer (A) of “Private seal” is selected by the user, and a click operation is performed on a “Next” button 52a, on the question/answer page 52, then the next question/answer page (not shown) is displayed. On the next question/answer page, a question (Q) of “Is there a document in which an amount of transaction is written?” is displayed, and for example, two answers, an answer (A) of “Yes” with the tag of “Often selected” and an answer (A) of “No” are displayed as answer choices for the user. For the question, a comment is given, such as “The document includes (not only a contract document) but also a purchase order, a receipt, an estimation sheet, and the like. An example of ‘a document without an amount’ is a nondisclosure agreement”.

If, for example, an answer (A) of “Yes” is selected by the user, and a “Next” button is operated, on the question/answer page for answering whether the document exists or not, then the next question/answer page (not shown) is displayed. On the next question/answer page, a question (Q) of “Is a document of the electronically concluded contract to be printed out?” is displayed, and, for example, two answers of an answer (A) of “Not to be printed out” with the tag of “Often selected” and an answer (A) of “To be printed out” are displayed as answer choices for the user. For “Not to be printed out”, a comment such as “To be stored as an electronic file” is given.

If any of the answers (A) of “Not to be printed out” and “To be printed out” is selected by the user, and a click operation of a “Next” button is performed, on the question/answer page for answering whether the contract document is to be printed out or not, then the next question/answer page (not shown) is displayed. On the next question/answer page, a question (Q) of “To be linked with another system?” is displayed, and, for example, two answers (A) of “No” with the tag of “Often selected” and “Yes” are displayed as answer choices for the user.

If, for example, any of the answers (A) of “Yes” and “No” is selected by the user, and a click operation of a “Next” button is performed, on the question/answer page for answering whether or not to be linked with another system, then the next question/answer page (not shown) is displayed. On the next question/answer page, a question (Q) of “Which provision form?” is displayed, and, for example, two answers (A) of “Cloud” with the tag of “Often selected” and “On-premises” are displayed as answer choices for the user. For “Cloud”, a comment such as “For a company without its own server” is given. For “On-premises”, a comment is given, such as “For a company with its own server. Not selected for software equipped with a contract conclusion function because such software is entirely cloud-based”.

If, for example, any of the answers (A) of “Cloud” and “On-premises” is selected by the user, and a click operation of a “Next” button is performed, on the question/answer page for making an answer about a provision form, then the next question/answer page (not shown) is displayed. On the next question/answer page, a question (Q) of “How many people are to use software?” is displayed, and, for example, a numerical input field such as “[ ] persons; the number of users: [ ] users” is displayed as an answer (A) by the user.

If, for example, a numerical value such as “10 persons” is inputted by the user as the answer (A), and a click operation of a “Next” button is performed, on the question/answer page for answering the number of people to use software, then the next question/answer page (not shown) is displayed. On the next question/answer page, a question (Q) of “How many contract documents are to be ‘sent’ in a month?” is displayed, and, for example, a numerical input field such as “H documents” is displayed as an answer (A) by the user.

If, for example, a numerical value such as “100 documents” is inputted by the user as an answer (A), and a click operation of a “Next” button is performed, on the question/answer page for answering the number of contract documents to be “sent” in a month, then the expression form conversion unit 113 converts the request of the user expressed in a form including the general first expression form to the technical second expression form based on the answers (A) given by the user so far. Then, a selection condition confirmation page 53 shown in FIGS. 8 and 9 is displayed as selection conditions set based on a result of the conversion.

On the selection condition confirmation page 53, for example, “Target work”, “Contract method”, “Compatibility with Act on Electronic Signatures and Certification Business with regard to electronic file storage”, “System linkage”, “Provision form”, “The number of users” and “The number of documents transmitted” are displayed as the selection conditions (items) based on the request of the user in the technical second expression form. Thus, for each item on the selection condition confirmation page 53, a question (Q) to the user and an answer (A), and a selection condition based on the request of the user expressed in the technical second expression form are displayed.

When the user who has confirmed the content on the selection condition confirmation page 53 performs a click operation on an “Evaluate software under the selection conditions” button 53a in a bottom part of FIG. 9B, the selection condition setting unit 114 sets (stores) each of the items (each of the selection conditions) described above in the selection condition DB 500.

At the same time, a search unit 141 of the presentation unit 115 reads pieces of information about one or more pieces of software that meet at least one of the selection conditions from the software DB 600, based on the selection conditions set in the selection condition DB 500. Then, a comparison table creation unit 142 arranges the pieces of information about the searched one or more pieces of software so that they can be compared and displays an electronic contract service list on an electronic contract service list page 54 shown in FIGS. 10 and 11.

On the electronic contract service (software) list, which is a search result, a tool name, a plan, and a monthly fee as well as information about the selection conditions are displayed for each of electronic contract services (the one or more pieces of software read from the software DB 600 as the piece of information). The order of displaying tool names of the electronic contract services (pieces of software) is, for example, in descending order of the number of items that meet selection conditions. For example, twenty products among a total of three hundred products (pieces of software), that is, “twenty products/all the three hundred products” are displayed in descending order of the number of selection conditions that are met. For a predetermined electronic contract service (one piece of software), a “0” symbol is displayed for an item that meets a predetermined selection condition among the selection conditions (that is, in the case of having specifications and the like that meet the predetermined selection condition); an “X” symbol is displayed when there is no selection condition item (that is, in the case of not having the specifications and the like that meet the predetermined selection condition); and such an item that it is unknown whether the item meets the selection condition (that is, in the case where it is unknown whether having or not the specifications and the like that meet the predetermined selection condition) is grayed out.

On the page 54, it is possible for the user to read the selection conditions in detail or change them. The selection conditions can be stored to be reused. Further, search results can be narrowed down or sorted.

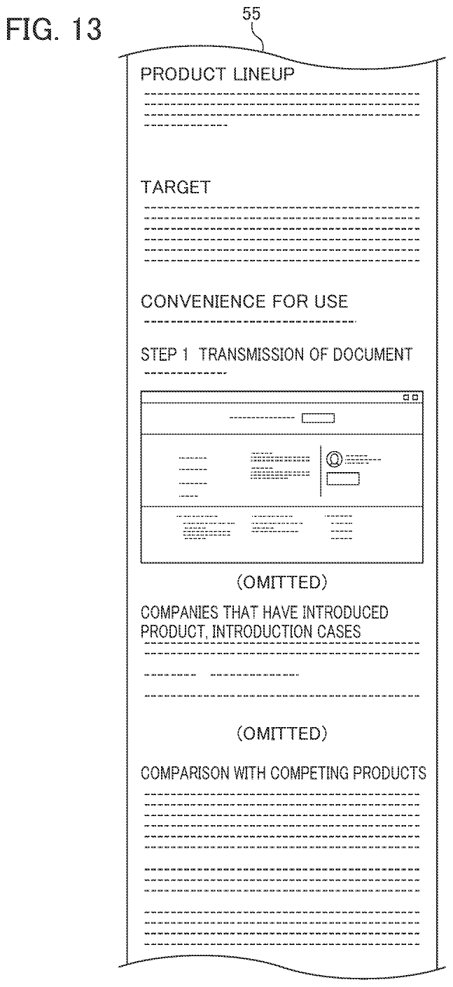

When the user performs a click operation on an icon or tool name of a desired tool (software) among tools displayed on the electronic contract service list, a page 55 of detailed information about tools of individual electronic contract services are displayed as shown in FIGS. 12 to 14. The page 55 shown in FIGS. 12 to 14 is a page on which, for example, a tool (software) of Electronic Contract A is shown. The user can know details of the tool (software) of Electronic Contract A by viewing the page 55.

When the user performs a click operation on a Plan button 55a on the tool details page 55 shown in FIG. 12, a plan page 56 shown in FIGS. 15 and 16 is displayed. A plan of the tool (software) of Electronic Contract A is shown on the plan page 56, and the user can know the plan of the tool (software) of Electronic Contract A by viewing the page 56.

An embodiment of the present invention has been described above. The present invention, however, is not limited to the above embodiment, and modifications, improvements, and the like are included in the present invention as far as the object of the present invention is achieved.

Though, in the above embodiment, the server 1 discloses the software comparison site on the Internet to cause the user accessing the software comparison site to view information about software, the present invention is not limited thereto. For example, by the server 1 publishing application software (hereinafter referred to as “an application”) of the software comparison site on the Internet and causing the user terminal 2 to download and execute the application, similar functions can be realized. Though, in the above embodiment, it has been described that a tool of an electronic contract service is found as software, various combinations are additionally conceivable.

For example, at the time accepting the request of the user in the general first expression form, the acceptance unit 112 may decide “to give (to ask)”/“not to give (not to ask)” a predetermined question (Q), based on a predetermined method.

Here, as the predetermined method, for example, qualitative decision and quantitative decision exist. The qualitative decision is a method of, when the above-described question/answer logic in which question/answer sets branch in a tree structure (the logic in which the question/answer sets are sequentially presented like a flowchart) is adopted, deciding “to give (to ask)”/“not to give (not to ask)” the next question (Q) according to an answer (A) to the previous question (Q). Specifically, for example, at the time of searching for an electronic contract service tool as an example of software, if an answer (A) of Yes is given to a previous question (Q) about whether “Target work: contract conclusion” applies or not, the acceptance unit 112 “gives (asks)” a question (Q) about “Contract method” as the next question (Q). On the other hand, if an answer (A) of No is given, the acceptance unit 112 “does not give (does not ask) the question (Q) about “Contract method” as the next question (Q). Thereby, it is possible to prevent the user from making an answer (A) from choices that is unnecessary for the user.

In comparison, the quantitative decision is a method of, for example, converting a plurality of answers (A) to a plurality of questions (Q) to scores and deciding “to give (to ask)”/“not to give (not to ask)” according to the value of each score. Specifically, it is assumed that, for example, at the time of searching for a CRM (customer relationship management) tool as another example of software, a plurality of “questions (Q)” are “How many users?”, “IT knowledge?”, “Costs/man-hours that can be spent?”, and the like. In this case, the acceptance unit 112 may decide whether a question (Q) about highly functional and complicated CRM is “to be given (to be asked)”/“not to be given (not to be asked)” or a question (Q) about lowly functional and simple CRM is “to be given (to be asked)”/“not to be given (not to be asked)” as the next question(Q) according to scores based on answers (A) to the above questions (Q). For example, if the plurality of sets of “question (Q): answer (A)” are “The number of users: small”, “IT knowledge: without”, and “Costs/man-hours that can be spent: low”, the acceptance unit 112 may “give (make)” a question (Q) about detailed requirements of simple CRM to recommend not the highly functional and complicated CRM but the lowly functional and simple CRM.

Similarly, the label applying unit 131 of the acceptance unit 112 may decide “to apply”/“not to apply” a label based on qualitative decision or quantitative decision.

For example, the following is an example of being based on qualitative decision. That is, it is assumed that, at the time of searching for an SFA tool as another example of software, sets of “question (Q): answer (A)” of the previous time and the time before the previous time shown like a flowchart are “Company scale: large” and “Business category: beauty clinic”, respectively. In this case, since the number of business negotiations is large, and a yield improvement effect is expected, the label applying unit 131 may “apply” the label of “Often selected” to an answer (A) of “Budget control function” among answer choices for the next question. In other cases, the label applying unit 131 may “not” apply the label of “Often selected” to the answer (A) of “Budget control function”.

In comparison, for example, the following is an example of being based on quantitative decision. That is, it is assumed that, at the time of searching for a CRM tool as another example of software, “Which departments are to use?”, “Company scale?”, “Costs that can be spent?” and the like exist as a plurality of questions (Q). These questions (Q) are mere examples, and all of them are not necessarily required. In this case, the label applying unit 131 may decide “to apply”/“not to apply” the label of “Often selected” to an answer (A) of “System linkage possible” among the next answer choices, according to scores based on a plurality of answers (A) to the above plurality of questions (Q). For example, it is assumed that a plurality of sets of “question (Q): answer (A)” are “Departments that are to use: sales, marketing, and customer support”, “Company scale: large”, and “Costs/man-hours that can be spent: high”. In this case, the label applying unit 131 may “apply” the label of “Often selected” to the answer (A) of “System linkage possible” among the next answer choices, according to scores based on the above answers (A).

Similarly, the expression form conversion unit 113 may convert the request of the user in the general first expression form accepted by the acceptance unit 112 to the technical second expression form based on qualitative decision or quantitative decision.

For example, the following is an example of being based on qualitative decision. That is, it is assumed that, at the time of searching for an electronic contract service tool as an example of software, a plurality of question/answer sets are given like a flowchart, and, as a result, the request of the user in the general first expression form is “There is a document in which an amount of transaction is written” but “a document of an electronically concluded contract is not printed out”. In this case, the expression form conversion unit 113 can convert such a general first expression form to a technical second expression form such as “Compatibility with Act on Electronic Signatures and Certification Business with regard to electronic file storage”.

In comparison, for example, the following is an example of being based on quantitative decision. That is, it is assumed that, at the time of searching for web production software as an example of software, a plurality of questions (Q) are “Complicatedness of needs”, “Desired degree of freedom of design”, “IT knowledge?” and “Costs/man-hours that can be spent”. These are mere examples, and all of these questions (Q) are not necessarily required. In this case, the expression form conversion unit 113 may convert the expression form to the request of the user in the technical second expression form, according to scores based on answers (A) based on the plurality of questions (Q), that is, scores based on the request of the user in the general first expression form. For example, a plurality of sets of “question (Q): answer (A)” are “Complicatedness of needs: high”, “Desired degree of freedom of design: high”, “IT knowledge: high”, and “Costs/man-hours that can be spent: high”. In this case, the expression form conversion unit 113 may perform conversion to the request of the user in the technical second expression form, such as “Provision form: on-premises (not cloud)”, based on scores based on answers (A) based on the plurality of questions (Q), that is, scores based on the request of the user in the general first expression form.

In addition, the server 1 can have various kinds of functions that are not limited to the embodiment described above. For example, the server 1 may refer to a past use history (or used software used that has been registered) of an employee (another user) of the same company and present software that can be linked with the software, to the user. Further, for example, the server 1 may pick up cases close to a situation of questioning and answering. Further, for example, the server 1 may provide a bulletin board so that users exchange information. Further, for example, the server 1 may provide action histories of buyers to vendors. In this case, since the user can use the action histories as a marketing reference as a vendor, utilization is expected as a business tool. Further, for example, the server 1 may accept a question in free words/a natural language to make a judgment with AI. Further, for example, the server 1 may refer to diagnosis cases of other companies to set selection conditions though, in general, the setting is performed from the beginning without making use of anything. Further, for example, the server 1 may issue an alert when a choice with a label of “Non-recommended” is selected, based on feedback of trouble cases. Further, for example, the server 1 may accumulate results of questioning and answering and socioeconomic characteristic data that the user has, and distribute advertisements or e-mails to the user as necessary or make a recommendation to the user.

Further, for example, the series of processes described above can be executed by hardware or can be executed by software. In other words, the functional configuration shown in FIG. 4 is a mere example, and the present invention is not limited thereto. That is, it is sufficient if the information processing system is provided with a function capable of executing the series of processes described above as a whole, and which functional blocks and databases are to be used to realize the function is not limited to the example of the drawing. Further, existence places of the functional blocks and the databases are not especially limited to the drawing but may be optional. For example, the functional blocks and databases of the server 1 may be divided and transferred to a plurality of computers. On the contrary, the functional blocks of the user terminal 2 and the databases may be transferred to the server. Further, each of one functional block and one database may be configured with a single piece of hardware, a single piece of software, or a combination thereof.

In the case of causing the series of processes to be executed by software, a program constituting the software is installed into a computer or the like from a network or a recording medium. The computer may be a computer incorporated in dedicated hardware. The computer may be a computer capable of executing various kinds of functions by various kinds of programs being installed, for example, a general purpose smartphone or personal computer, in addition to a server.

A recording medium that includes such a program is not only configured with a removable medium not shown, which is distributed separately from an apparatus body, to provide the program to the user and the like but configured with a recording medium or the like provided for the user and the like in a state of being incorporated in the apparatus body in advance.

In the present specification, steps written by the program recorded in a recording medium include not only processes performed in time series in order but also processes that are not necessarily performed in time series but are performed in parallel or individually. In the present specification, the term of system is assumed to mean an entire apparatus configured with a plurality of devices, a plurality of means, and the like.

In other words, an information processing apparatus to which the present invention is applied is sufficient if it has the following configuration, and can take various embodiments. That is, an information processing apparatus (for example, the server 1 of FIG. 4) to which the present invention is applied includes:
acceptance unit (for example, the acceptance unit 112 of FIG. 4) accepting a request of a user for software in a form including a general first expression form (for example, desiring to digitize one-hundred-people-scale contract work using registered seals without printing);
conversion unit (for example, the expression form conversion unit 113 of FIG. 4) converting the request accepted in the first expression form into a technical second expression form (for example, contract conclusion, electronic signature, electronic file storage, and one hundred or more users); setting unit (for example, the selection condition setting unit 114 of FIG. 4) setting one or more selection conditions for selecting software (for example, contract conclusion, electronic signature, electronic file storage, and one hundred or more users) based on the request converted in the second expression form; and
presentation unit (for example, the presentation unit 115 of FIG. 4) presenting one or more pieces of software to the user based on the one or more selection conditions. By making a configuration as described above, the request of the user in the general first expression form (a request of the user for conditions for software, and the like) is converted to the technical second expression form (terms for selection conditions on the site operation side) to search for software. That is, for the user, only by making a request in the general first expression form, one or more pieces of software that meet his request converted from the general first expression form to the technical second expression form are presented. Thus, it is possible for the user to easily find software that includes functions the user requires.

The acceptance unit (for example, the acceptance unit 112 of FIG. 4) accepts the request of the user in the first expression form by repeating questioning to and answering from the user. Thereby, it is possible to, while repeating questioning to and answering from the user, accept the request of the user as a system, and, therefore, it is possible to present what is closer to software that the user requires, to the user.

An answer to a question in the questioning and answering is selected from choices; and the acceptance unit (for example, the acceptance unit 112 of FIG. 4) includes label applying unit (for example, the label applying unit 131 of FIG. 4), the label applying unit applying a label to at least one answer among the choices. Thereby, when wondering which choice is to be selected, the user can select a choice depending on a label such as “Often selected”.

### EXPLANATION OF REFERENCE NUMERALS

1 Server
2 User terminal
11 CPU
18 Storage unit
19 Communication unit
111 Web server unit
112 Acceptance unit
113 Expression form conversion unit
114 Selection condition setting unit
115 Presentation unit
121 Site disclosure unit
131 Label applying unit
141 Search unit
142 Comparison table creation unit
300 User information DB
400 Question/answer DB
500 Selection condition DB
600 Software DB

1. An information processing apparatus comprising:
an acceptance unit accepting a request of a user for software in a form including a general first expression form;
a conversion unit converting the request accepted in the first expression form into a technical second expression form;
a setting unit setting one or more selection conditions for selecting software based on the request converted in the second expression form; and
a presentation unit presenting one or more pieces of software to the user based on the one or more selection conditions.

2. The information processing apparatus according to claim 1, wherein the acceptance unit accepts the request of the user in the first expression form by repeating questioning to and answering from the user.

3. The information processing apparatus according to claim 2, wherein
an answer to a question in the questioning and answering is selected from choices; and
the acceptance unit comprises label applying unit, the label applying unit applying a label to at least one answer among the choices.

4. An information processing method executed by an information processing apparatus, the information processing method comprising the steps of:
accepting a request of a user for software in a form including a general first expression form;
converting the request accepted in the first expression form into a technical second expression form;
setting one or more selection conditions for selecting software based on the request converted in the second expression form; and
presenting one or more pieces of software to the user based on the one or more selection conditions.

5. A non-transitory computer readable medium storing a program causing a computer controlling an information processing apparatus to execute a control process, the control process comprising the steps of:
accepting a request of a user for software in a form including a general first expression form;
converting the request accepted in the first expression form into a technical second expression form;
setting one or more selection conditions for selecting software based on the request converted in the second expression form; and
presenting one or more pieces of software to the user based on the one or more selection conditions.
